(19) United States
(12) Patent Application Publication
(10) Pub. No.: US 2011/0196741 A1
(43) Pub. Date: Aug. 11, 2011

(54) ONLINE AND OFFLINE INTEGRATED PROFILE IN ADVERTISEMENT TARGETING

(75) Inventors: Neeraj Gupta, Santa Clara, CA (US); Naveen Gupta, Sunnyvale, CA (US)

(73) Assignee: Yahoo! Inc., Sunnyvale, CA (US)

(21) Appl. No.: 12/702,854

(22) Filed: Feb. 9, 2010

(51) Int. Cl. G06Q 30/00

(52) U.S. Cl. 705/14.53

(57) ABSTRACT

The present invention provides techniques for generation and use of an online and offline integrated profile for a person, for use in advertisement targeting. The integrated profile may be generated based at least in part on obtained historical offline and online consumer-related behavior information relating to the person. Online or offline advertisements are then targeted to the person based at least in part on the profile. Use and association of online and offline unique identifiers for the person can allow sharing of targeting information between online and offline entities while maintaining a degree of privacy with regard to the person.

### BACKGROUND

Targeting, including behavioral targeting, is of great use in advertising. Furthermore, the more accurate, precise and specific the targeting, the greater the use and effectiveness.

Entities such as online portals may have access to huge amounts of consumer-related information on users, including information on the behavior, interests, content consumption, pre-purchasing and purchasing behavior of users. This information allows a high degree of targeting using both aggregated information and information on individual users. Moreover, additional targeting techniques including time-based targeting, geotargeting, demographic targeting, etc., can further enhance the effectiveness of targeted advertising.

However, in addition to the wealth of online information available for use in user targeting, there exists a huge amount of offline consumer-related information, including historical consumer-related behavior of individuals.

There is a need for improved techniques relating to targeted online and offline advertising.

### SUMMARY

Some embodiments of the invention provide systems and methods for generation and use of an online and offline integrated profile for a person, for use in advertisement targeting. The integrated profile may be generated based at least in part on obtained historical offline and online consumer-related behavior information relating to the person. Techniques according to embodiments of the invention can be used to generate integrated profiles for each of a large number of people. In some embodiments, profiles for each person are generated using a machine learning technique or model that utilizes historical online and offline consumer-related information relating to other users.

Online and offline advertisements are then targeted to the person based at least in part on the profile. Use and association of online and offline unique identifiers for a person can allow sharing of targeting information between online and offline entities while maintaining a degree of privacy with regard to the person.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention; and

FIG. 4 is a block diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Herein, the term “profile” is broadly intended to include, among other things, any collection, set or group of information associated with an individual or a group, or any collection, set or group of associated information relating to anything or any entity or entities.

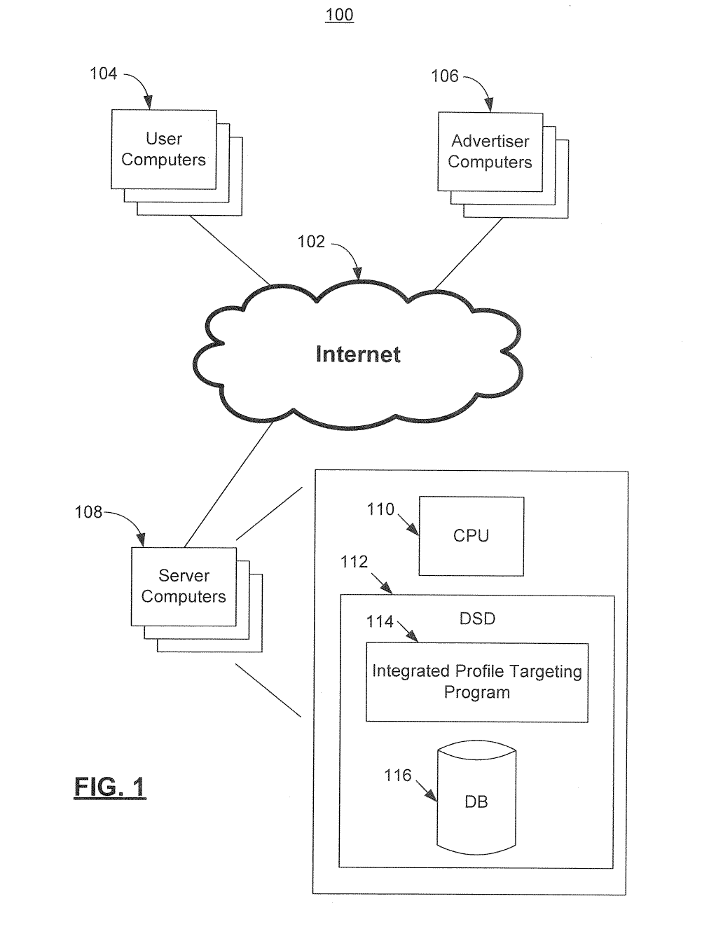

FIG. 1 is a distributed computer system 100 according to one embodiment of the invention. The system 100 includes user computers 104, advertiser computers 106 and server computers 108, all coupled or coupleable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Integrated Profile Targeting Program 114.

The Program 114 is intended to broadly include all programming, applications, algorithms, software and other tools necessary to implement or facilitate methods and systems according to embodiments of the invention. The elements of the Program 114 may exist on a single server computer or be distributed among multiple computers or devices.

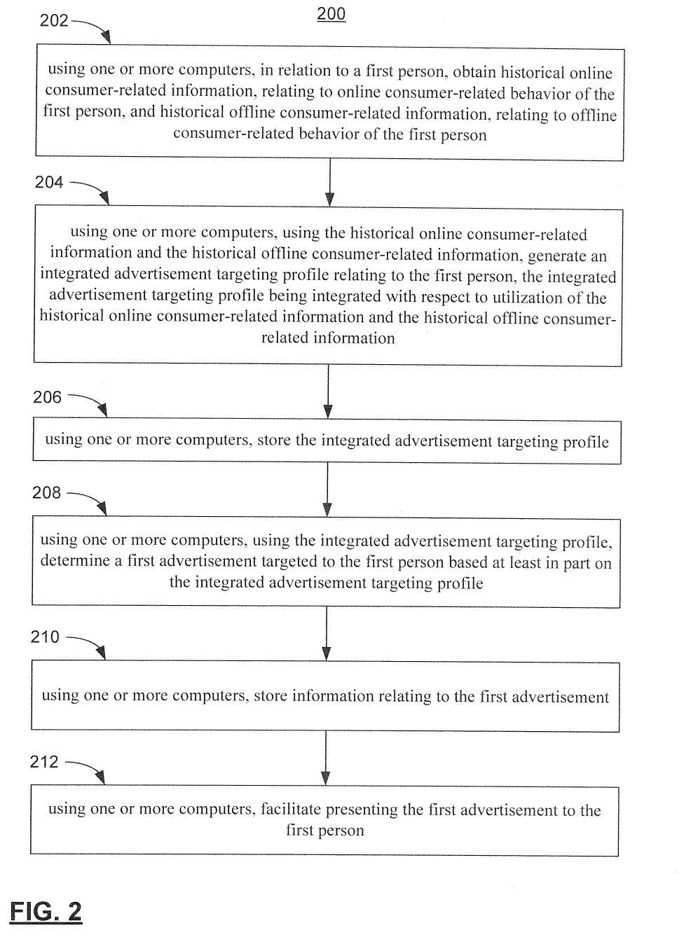

FIG. 2 is a flow diagram illustrating a method 200 according to one embodiment of the invention. At step 202, using one or more computers, in relation to a first person, information is obtained, including historical online consumer-related information, relating to online consumer-related behavior of the first person, and historical offline consumer-related information, relating to offline consumer-related behavior of the first person.

At step 204, using one or more computers, using the historical online consumer-related information and the historical offline consumer-related information, an integrated advertisement targeting profile is generated relating to the first person. The integrated advertisement targeting profile is integrated with respect to utilization of the historical online consumer-related information and the historical offline consumer-related information.

At step 206, using one or more computers, the integrated advertisement targeting profile is stored.

At step 208, using one or more computers, using the integrated advertisement targeting profile, a first advertisement is determined, the first advertisement being targeted to the first person based at least in part on the integrated advertisement targeting profile.

At step 210, using one or more computers, information is stored relating to the first advertisement.

At step 212, using one or more computers, presentation of the first advertisement to the first person is facilitated.

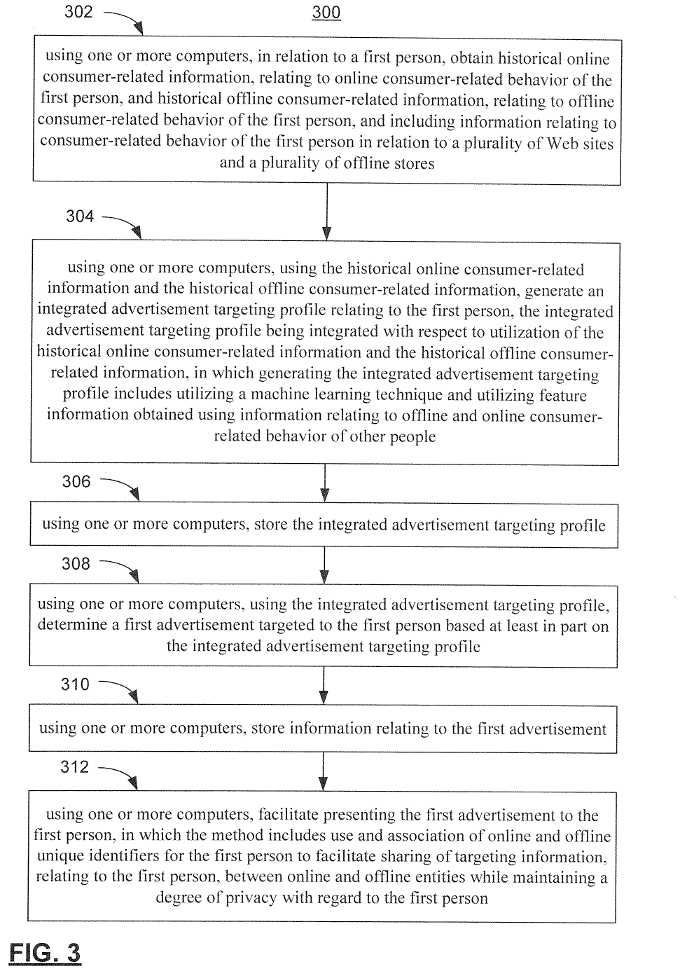

FIG. 3 is a flow diagram illustrating a method 300 according to one embodiment of the invention. At step 302, using one or more computers, in relation to a first person, information is obtained, including historical online consumer-related information, relating to online consumer-related behavior of the first person, and historical offline consumer-related information, relating to offline consumer-related behavior of the first person. The obtained information includes information relating to consumer-related behavior of the first person in relation to a plurality of Web sites and a plurality of offline stores.

At step 304, using one or more computers, using the historical online consumer-related information and the historical offline consumer-related information, an integrated advertisement targeting profile relating to the first person is generated. The integrated advertisement targeting profile is integrated with respect to utilization of the historical online consumer-related information and the historical offline consumer-related information. Generating the integrated advertisement targeting profile includes utilizing a machine learning technique and utilizing feature information obtained using information relating to offline and online consumer-related behavior of other people.

Steps 306, 308 and 310 are similar to steps 206, 208 and 210 as depicted in FIG. 2.

At step 312, using one or more computers, presentation of the first advertisement to the first person is facilitated. The method 300 includes use and association of online and offline unique identifiers for the first person to facilitate sharing of targeting information, relating to the first person, between online and offline entities while maintaining a degree of privacy with regard to the first person.

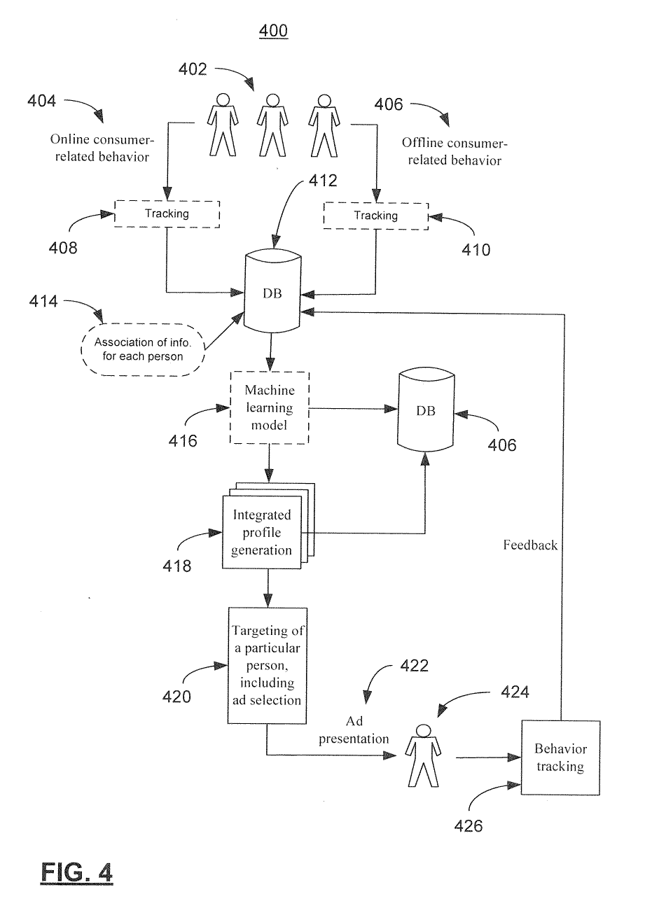

FIG. 4 is flow diagram illustrating a method 400 according to one embodiment of the invention.

Multiple people 402 are represented. As depicted, for each of the people 402, online consumer-related behavior 404 is tracked 408, and offline consumer-related behavior 406 is tracked 410. Information relating to the tracked behavior is stored in a database, such as database 412. The information stored in the database 412 is associated 414 such that offline information for a particular person is associated with online information for the particular person.

Block 416 represents generation of a machine learning model, using the tracked information regarding the people 402. The machine learning model is stored in a database, such as database 406.

Block 418 represents generation of integrated profiles for each of the people 402, using output from the machine learning model. The profiles are integrated from the perspective of utilizing both offline and online consumer-related behavior information. The profiles are stored in a database, such as the database 406. It is to be understood that, in some embodiments of the invention, machine learning techniques and models may be used in other aspects as well, such as in targeting users and selecting advertisements.

Block 420 represents targeting of a particular person for presentation of an advertisement, including selection of a targeted advertisement.

The targeted advertisement is then presented 422 to the particular person 424.

Block 426 represents tracking of behavior of the particular person 424 in association with the targeted advertisement. The tracked behavior can then be used as feedback to add to stored consumer-related behavior for many people. Such feedback can be used to update or refine the machine learning model, which can lead to better integrated profiles for people, and consequently better advertisement targeting, relevance and performance.

It is to be noted that, while, for simplicity, targeting of an advertisement to one particular person is depicted, many people may of course be so targeted, and their behavior may provide feedback as described. Furthermore, it is to be noted that the feedback can be a repeating cycle or loop, leading to ever greater refinement of modeling, profile generation, and ultimately advertisement targeting, relevance and performance.

Some embodiments of the invention help bridge the gap between online and offline entities and information, allowing deeper profiling and targeting, and better relevance. It is noted that, although various embodiments of the invention are described with information flowing from an online entity to an offline entity or vice versa, generally, both directions are contemplated, and techniques described in connection with an offline or online entity may often may be usable by either an online or an offline entity.

Some embodiments of the invention include generation and use on an integrated advertisement targeting profile for a person, the profile being integrated with respect to usage of historical online and offline consumer-related behavior information for the person. In some embodiments, an integrated profile may synergistically utilize offline and online information, rather than merely combining it in a simple or less effective way. For instance, in some embodiments, an integrated profile makes use of associations and learning that can be accomplished using related pieces of online and offline information, in some embodiments using machine learning. This can allow generation of profile information that is greater than the sum of each piece of information independently. As just one example, in some cases, related online and offline behavior may indicate a particular intent, interest, or interest category, such as a lead-up with respect to a purchase of a particular type of product. The topical relationship, and perhaps temporal relationship and progression, which may be suggested, learnable, or indicated by the offline and online information, may, if properly combined or analyzed, suggest a strong probability of purchase in the near future. In effect, in some cases it is not only the offline and online information independently, even if considered together, that are helpful in profiling. Rather, in addition, in some cases, relationships and associations between pieces of online and offline information may suggest progressions, intentions, granularities, etc. that might not otherwise be discernable. Some embodiments of the invention also utilize the notion that online intent affects or influences offline intent, and vice versa.

In some embodiments, integrated profiles make use of the offline and online information as well as relationships and associations between the two. In some embodiments, machine learning techniques can be used in generating the integrated profiles. Such techniques may use feature information form great many users as well as their consumer-related behavior and perhaps other types of behavior or characteristics, to help inform or generate, through use of the model, a profile for a particular person. Some embodiments not only make synergistic use of online and offline information, but also make use of aggregate online and offline information for many users.

Consumer-related behavior information can include a large variety of information, such as information relating to consumption, interest, or purchase of information, content, items, products or services. For example, consumer-related information can include information relating to a person's access to or interaction with Web sites as well as offline businesses and stores.

In some embodiments, the integrated profile is generated using information that includes, in addition to online information, a rich variety of offline information. For example, shopping behavior (where available, whether or not leading to actual purchase) at multiple stores over a long period of time can be included.

In some embodiments, stores cooperate or are otherwise associated with an online entity, such as a Web portal entity. The Web portal may have access to a huge amount of online behavioral information relating to a great many users. Of course, behavioral targeting utilizing this information can be used, as well as many other types of targeting, such as time-based targeting, geotargeting, demographic targeting, etc. In some embodiments, the Web portal enriches its database of consumer-related behavioral information on users by its association with offline entities, such as offline stores, including physical stores. The Web portal can then use the offline information on users, as well as the online information, in generating integrated profiles for users, and in targeting. Furthermore, through collaboration, entities including offline entities can target people with advertisements such as offline advertisements based at least in part on integrated profile information (and vice versa).

Although many different online and offline tracking techniques are contemplated by embodiments of the invention, some embodiments use online tracking techniques using cookies. For instance, in some embodiments, cookies relating to logged in users, or L cookies, such as, for example, users logged into a Web portal, Web site, or an email account, are used to track user behavior. Furthermore, in some embodiments, cookies relating to users who are not logged in, or B cookies, are utilized, including cookies that make use of IP addresses to identify or help identify an individual user or group of users. Some embodiments use information obtained through use of both L cookies and B cookies.

As mentioned, some embodiments of the invention contemplate cooperation, collaboration, and information sharing between an online entity as a Web portal and an offline entity such as an offline store. For example, the portal and store can selectively electronically communicate information and reporting with each other.

Offline stores, for instance, typically track offline consumer-related behavior of customers. The information is typically stored in one or more electronic databases. Of course, an online entity such as a Web portal also stores tracked user behavior information in one or more databases. Through networking such as the Internet, for instance, information can be communicated between the online entity and the offline entity, such as the Web portal and offline store.

Offline stores, for instance, may track customer behavior using a unique identifier associated with each customer, such as a store card number, for example. Web portals, for example, also track users using unique identifiers, such as login IDs, etc. In some embodiments of the invention, offline and online identifiers may be associated so as to associate online and offline consumer-related information for each of many individuals. For example, offline and online consumer-related information may be communicated to a database and associated.

Although the invention contemplates sharing of information between offline and online entities, some embodiments also contemplate various techniques for ensuring a desired degree of privacy regarding sharing of information on individuals. For example, in some embodiments, a Web portal may communicate user consumer-related information to an offline store for the store's use in targeting users, but in a selective, aggregated, sanitized, encrypted or limited way.

Various measures to ensure a degree of privacy or limit degree of sharing may be taken. For instance, in some embodiments, a Web portal may use a login ID or email address to identify a user in an internal database. Rather than sharing consumer-related information with a store in association with the login ID or email address, the Web portal may instead use a different or encrypted identifier. For instance, the Web portal may use a proxy, different, or encrypted form of the login ID or email address when communicating the information to the store. In this way, a more sensitive identifier, or an identifier that may allow greater potential invasion of privacy or access to an actual identity, such as an email address or login ID, may be prevented from being shared, helping guard privacy and security.

Furthermore, the Web portal may send only limited information, and may sent it an aggregated fashion, for many users, to the store. The store may use the information to target groups of individual users falling into a particular interest group or targeting category. Still further, in embodiments of the invention in which online or offline coupons or other promotions are used, a coupon may include a unique identifier, and only certain targeting information may be included in consumer-related information associated with the coupon. In some embodiments, integrated profiles can be used to allow or enhance loyalty programs and other promotions, while yet ensuring or helping ensure privacy.

Some embodiments of the invention utilize online or offline coupons, which can be used to facilitate online entity and offline entity communication and collaboration, as well as limit information sharing and help guard privacy. For instance, in some embodiments, an online coupon may be targeted to and presented to a user or users. If a user clicks on (or otherwise selects) the coupon, a unique coupon code may be associated or stored in a cookie associated with the user. A cookie code and associated upon information may then be shared with an offline store, for instance, to allow targeting of the user (person) in some offline way.

For instance, the store may present or send an offline coupon, mailing, or other advertisement to the person. Furthermore, in some embodiments, store cards or codes, such as discount cards, reward cards, store credit cards, frequent flyer cards, etc., may be utilized. For example, store card codes can be associated with cookie codes and thereby associated with coupons. Furthermore, the store can electronically store integrated profiles for customers, making use of online information made available, as well as customer purchase history information, etc. Similarly, online entities can receive consumer-related information associated with individuals from stores, and can use this information along with online consumer-related information in generating integrated profiles. Moreover, offline and online entities may have months or years of consumer-related information on users, such as purchase history, travel history, etc. Such information can be valuable in integrated profile generation and quality, as well as in evaluating recentness and intensity factors used in targeting. This is an example of how offline and online entities can share information, and also an example of how online and offline profile information can be shared and utilized.

Some embodiments of the invention further enhance the appeal of highly targeted advertisements by using highly engaging forms of advertising, including, for example, video advertising, interactive advertising, rich media advertising, etc. The combination of a highly targeted advertisement, as may result from use of an integrated profile, and a highly engaging form of advertising, can lead to a high degree of advertising effectiveness and value.

Of course, some embodiments of the invention contemplate integrated profiles that include information from multiple offline and online sources. Online sources can include advertisers, publishers, publisher or other networks, exchanges, Web portals, other Web sites and entities, etc.

The following is a simple example illustrating use of an integrated profile according to some embodiments of the invention. Supposing a particular person, Brad, buys a Microsoft X-Box game console at an electronics store. The next day, Brad visits an electronics and gadgets review Web site. Without an integrated profile, an online entity might target Brad with a generic electronics advertisement. However, utilizing an integrated profile including information regarding Brad's recent purchase, Brad could be much more effectively and specifically targeted with an advertisement relating to an X-Box video game, perhaps using information regarding Brad's online information to influence which video game to advertise. Furthermore, if Brad buys the video game, this information can be shared with the electronics store where Brad bought the X-box. The electronics store could then target Brad with coupons for other related X-box games, etc.

As another example, supposing a shopper, Max, has demonstrated offline an interest in shopping for a cell phone. Max's online behavior also indicates that Max also likes to watch online videos. Using an integrated profile, while Max is online, Max could be targeted with an online Sprint phone video, for example.

The foregoing description is intended merely to be illustrative, and other embodiments are contemplated within the spirit of the invention.

1. A method comprising:
using one or more computers, in relation to a first person, obtaining historical online consumer-related information, relating to online consumer-related behavior of the first person, and historical offline consumer-related information, relating to offline consumer-related behavior of the first person;
using one or more computers, using the historical online consumer-related information and the historical offline consumer-related information, generating an integrated advertisement targeting profile relating to the first person, the integrated advertisement targeting profile being integrated with respect to utilization of the historical online consumer-related information and the historical offline consumer-related information;
using one or more computers, storing the integrated advertisement targeting profile;
using one or more computers, using the integrated advertisement targeting profile, determining a first advertisement targeted to the first person based at least in part on the integrated advertisement targeting profile;
using one or more computers, storing information relating to the first advertisement; and
using one or more computers, facilitating presenting the first advertisement to the first person.

2. The method of claim 1, wherein obtaining consumer-related information comprises:
obtaining information relating to access or consumption of information; and
obtaining information relating to purchasing behavior or purchasing interest behavior, wherein purchasing interest behavior includes behavior that appears to indicate a potential eventual interest in a purchase.

3. The method of claim 1, wherein obtaining consumer-related information comprises obtaining information about consumer-related behavior in association with a plurality of Web sites and in association a plurality of offline stores.

4. The method of claim 1, wherein storing the integrated advertisement targeting profile comprises storing the integrated advertisement targeting profile in one or more databases, and wherein storing the information relating to the first advertisement comprises storing the information relating to the first advertisement in one or more databases.

5. The method of claim 1, comprising obtaining historical offline and online consumer-related behavior information relating to each of a plurality of people, and comprising generating an integrated advertisement targeting profile for each of the plurality of people.

6. The method of claim 1, wherein generating the integrated advertisement profile for the first user comprises utilizing a machine learning technique.

7. The method of claim 1, comprising use and association of online and offline unique identifiers for the first person to facilitate sharing of targeting information, relating to the first person, between online and offline entities while maintaining a degree of privacy with regard to the first person.

8. The method of claim 1, wherein the historical offline consumer-related information comprises information relating to offline consumer-related behavior of the first user that occurred prior to any online consumer-related behavior of the first user relating to the historical online consumer-related information.

9. The method of claim 1, wherein the integrated advertisement targeting profile comprises information relating to determined interests of the first user.

10. The method of claim 1, wherein the integrated advertisement targeting profile comprises information relating to recentness and intensity of consumer-related behavior of the first user.

11. The method of claim 1, comprising presenting the first advertisement to the first user.

12. The method of claim 1, wherein facilitating presenting the first advertisement to the first user comprises facilitating presenting an online advertisement to the first user.

13. The method of claim 1, wherein facilitating presenting the first advertisement to the first user comprises facilitating presenting a video or rich media advertisement to the first user.

14. The method of claim 1, wherein the first advertisement is an offline advertisement.

15. The method of claim 1, comprising utilizing cookies in obtaining online consumer-related information.

16. The method of claim 1, comprising using an online coupon that can be redeemed in an offline store, and wherein the online coupon is associated with a unique identifier of the first user available to an online store.

17. A system comprising:
one or more server computers coupled to the Internet; and
one or more databases coupled to the one or more server computers;
wherein the one or more server computers are for:
in relation to a first person, obtaining historical online consumer-related information, relating to online consumer-related behavior of the first person, and historical offline consumer-related information, relating to offline consumer-related behavior of the first person;
using the historical online consumer-related information and the historical offline consumer-related information, generating an integrated advertisement targeting profile relating to the first person, the integrated advertisement targeting profile being integrated with respect to utilization of the historical online consumer-related information and the historical offline consumer-related information;
storing the integrated advertisement targeting profile in at least one of the one more databases;
using the integrated advertisement targeting profile, determining a first advertisement targeted to the first person based at least in part on the integrated advertisement targeting profile;
storing information relating to the first advertisement in at least one of the one or inure databases; and
facilitating presenting the first advertisement to the first person.

18. The system of claim 17, comprising targeting the first user with at least one offline coupon based at least in part on the historical online consumer-related information.

19. The system of claim 17, comprising targeting the first user with at least one online coupon based at least in part on the historical offline consumer-related information.

20. A computer readable medium or media containing instructions for executing a method comprising:
using one or more computers, in relation to a first person, obtaining historical online consumer-related information, relating to online consumer-related behavior of the first person, and historical offline consumer-related information, elating to offline consumer-related behavior of the first person, and comprising information relating to consumer-related behavior of the first person in relation to a plurality of Web sites and a plurality of offline stores;
using one or more computers, using the historical online consumer-related information and the historical offline consumer-related information, generating an integrated advertisement targeting profile relating to the first person, the integrated advertisement targeting profile being integrated with respect to utilization of the historical online consumer-related information and the historical offline consumer-related information;
wherein generating the integrated advertisement targeting profile comprises utilizing a machine learning technique and utilizing feature information obtained using information relating to offline and online consumer-related behavior of other people;
using one or more computers, storing the integrated advertisement targeting profile;
using one or more computers, using the integrated advertisement targeting profile, determining a first advertisement targeted to the first person based at least in part on the integrated advertisement targeting profile;
using one or more computers, storing information relating to the first advertisement; and
using one or more computers, facilitating presenting the first advertisement to the first person;
wherein the method comprises use and association of online and offline unique identifiers for the first person to facilitate sharing of targeting information, relating to the first person, between online and offline entities while maintaining a degree of privacy with regard to the first person.
